(19) United States
(12) Patent Application Publication
(10) Pub. No.: US 2021/0075888 A1
(43) Pub. Date: Mar. 11, 2021

(54) Diagnostic Meter For Workload Migration On Cloud

(71) Applicant: Prashant Shyamsundar Mishra, Redmond, WA (US)

(72) Inventor: Prashant Shyamsundar Mishra, Redmond, WA (US)

(21) Appl. No.: 16/566,920

(22) Filed: Sep. 11, 2019

(51) Int. Cl. H04L 29/08; G06F 9/54; G06F 9/50

(52) U.S. Cl. CPC H04L 67/34; G06F 9/5088; G06F 9/547; H04L 67/1002

(57) ABSTRACT

The subject matter described in this specification relates to the assessment & comparison of objects, facts, complete set up of cloud environment for migration, schedular, workload migration label, up-dates and upgrade of standards of software while migration on cloud. Cloud technology has the best functionality when it is updated on a regular basis to meet industry values.

Before migration it is needed to map few parameters of source & destination cloud for example objects, facts, software versions for the successful migration. Diagnostic system will check all this parameter are in suitable format or not. And diagnostic meter will show appropriate deflection for each stage of migration. Workload has been transmitted in the form of packets and in batches for better migration.

### TECHNICAL FIELD

The present invention described herein relates to migration of workload to the Cloud, more particularly updating software versions and upgrading software to industry standards during the migration process. This invention will ensure a migration achieves maximum efficiency by using the same information extracted for migration to perform updates and upgrades. This will save time and engineering efforts by analyzing the same information at once rather than in two different instances.

### BACKGROUND

When a consumer decides to migrate a workload into the Cloud or between Clouds, their sole focus is typically to complete the migration. However, it takes considerable amount of time and resources to extract relevant object information from the Source and the Destination.

Software updates and industry determined upgrades are just as necessary as the migration itself. Without updates and upgrades, the technology will not operate as intended and the migration to the cloud will not be satisfactory to the consumer.

Too often, Cloud consumers pay for the migration service to be complete and then discover that updates and upgrades are causing bugs in their newly migrated workloads. Consumer then must spend additional time and money to perform these instrumental updates and upgrades. Again, the same information extracted for migration must be extracted for this secondary task. To eliminate Cloud Consumers' expenditure on two services, plus the time lost extracting information from the source and destination, this invention combines migration with software version updates and industry-driven upgrades.

The proposed methodology will eliminate the task of manually updating& upgrading software once it has been migrated to the desired Cloud. Cloud consumer will experience a smoother migration onto the Cloud or between Clouds, as the technology will be compatible with all other technology updated & upgraded to industry standards. The consumer will save money, time and the human resources.

### SUMMARY

The First step in migration always begins with extracting object information from the Source and the Destination. Sources are often bare metal machines if the Consumer has not migrated to the Cloud yet; Consumer that have migrated to the Cloud in the past typically have Sources such as virtual machines, virtual private clouds, databases, storage, network or international data centers.

Source information is gathered from the workload that needs to be migrated and includes the size and file types of the data to be migrated. Destination are always the preferred Cloud, which can be from any cloud Provider. The Destination information is extracted from the APIs provided by the preferred Cloud Provider.

Once all relevant information is gathered, it is analyzed to complete an inventory of the workload that is to be migrated. This will determine the sequence of the migration, which relies upon (1) the architecture of the Source, (2) the topology of the Source network, (3) which software must undergo an update, and (4) which network elements must undergo industry-driven upgrades.

After the workload is inventoried and the sequence of the migration has been calculated, the workload undergoes software version updates and industry-driven upgrades. To begin with, each individual piece of software is checked to see if it is up-to-date:

IF Software is not up-to-date,
THEN identify newest version updates available with licensing key,
AND Perform Version update
AND check for completion
THEN repeat for all software in workload ELSE perform no updates
   Similarly, each network element must be checked for standards upgrades that would support optimal usability across Cloud platforms.

IF Network element is not up-to-date,
THEN identify the standards of destination Cloud that supports optimal usability
AND perform element upgrade
AND check for completion
THEN repeat for all elements in workload

ELSE perform no upgrades.

### BRIEF DESCRIPTION OF THE DIAGRAM

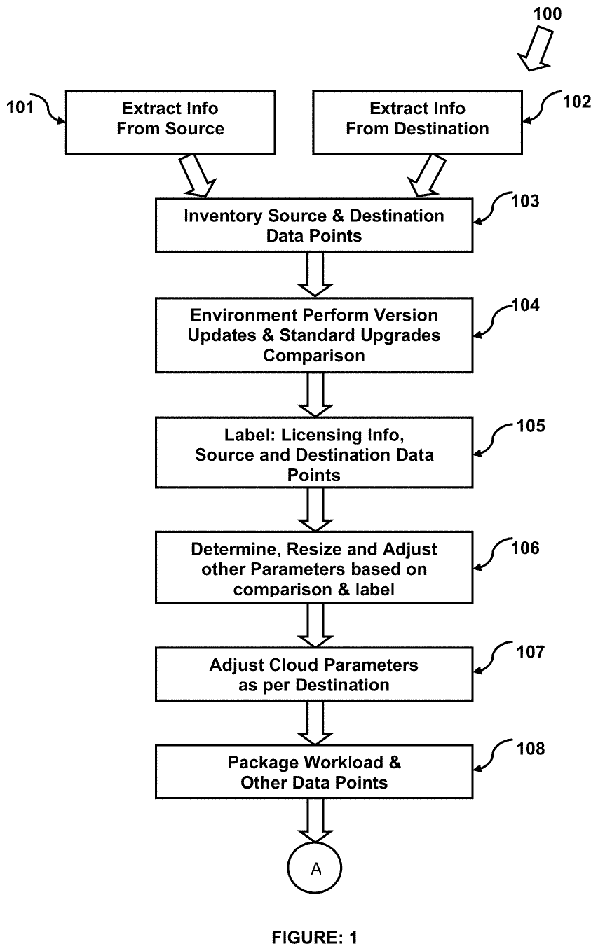

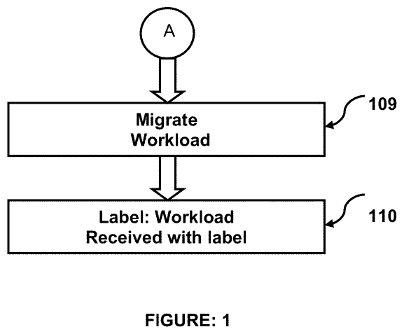

FIG. 1 is the flow chart of diagnostic meter for workload migration on cloud.

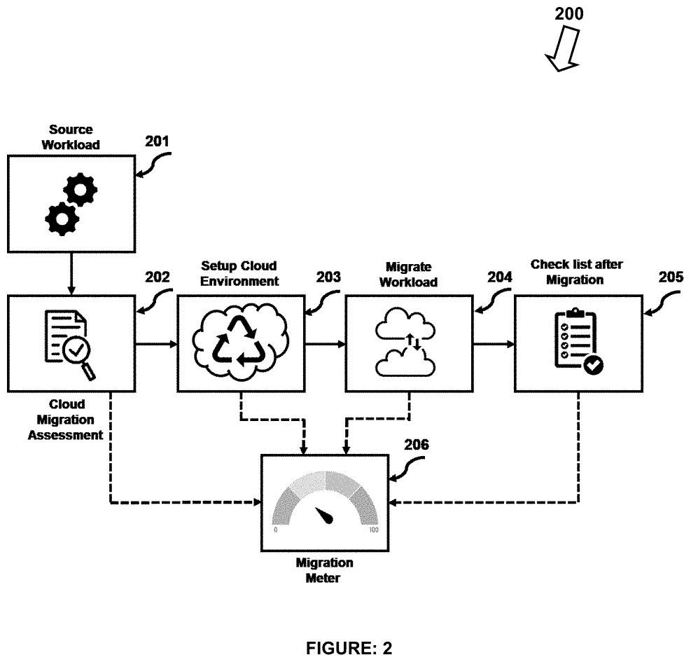

FIG. 2 is the block diagram of diagnostic meter for workload migration on cloud.

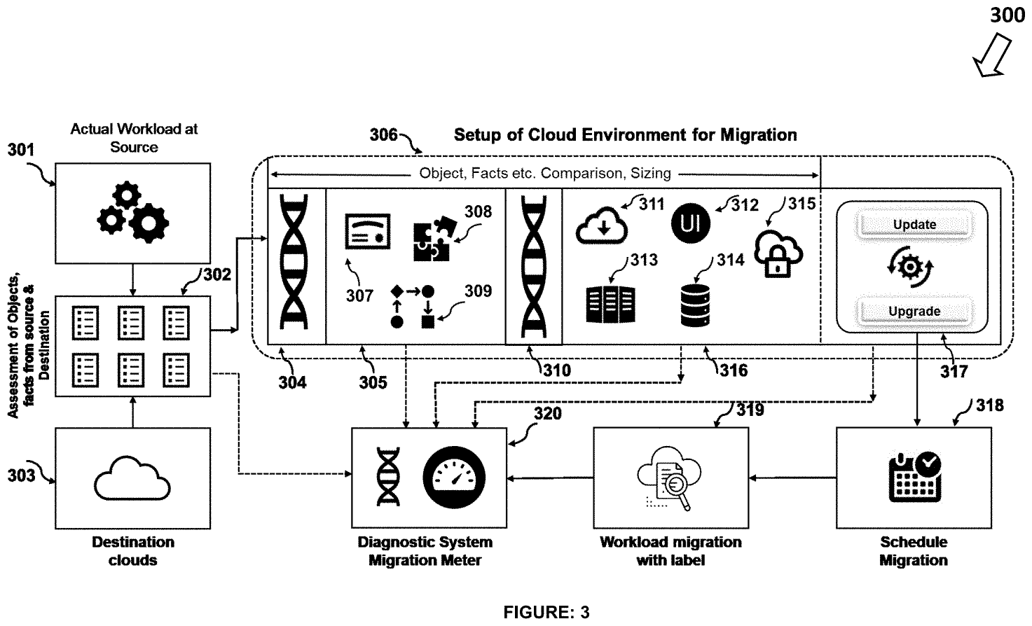

FIG. 3 is the functional block diagram of diagnostic meter for workload migration on cloud.

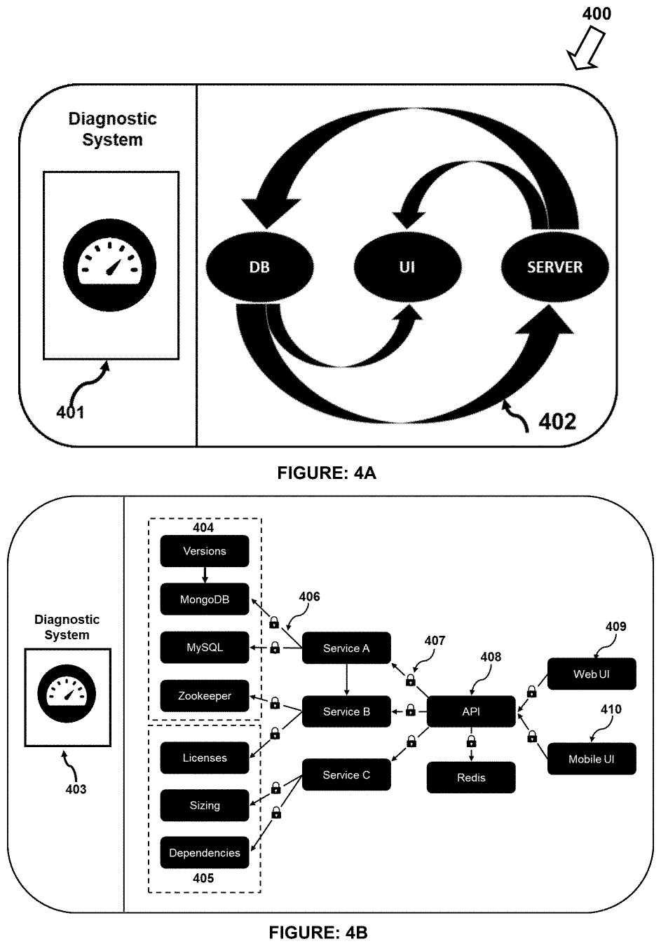

FIG. 4A and FIG. 4B is the types of source architecture mainly monolithic and modular showing infrastructure element, application element and diagnostic meter.

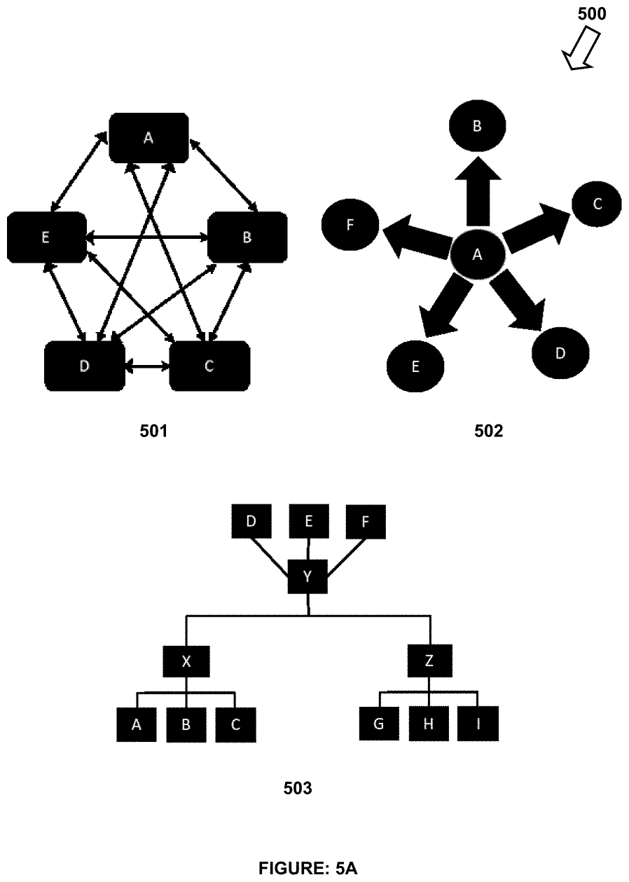

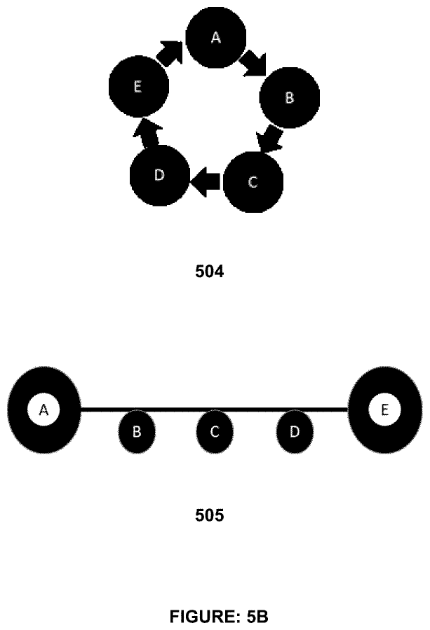

FIG. 5A and FIG. 5B is the network topology mainly central and linear network topology.

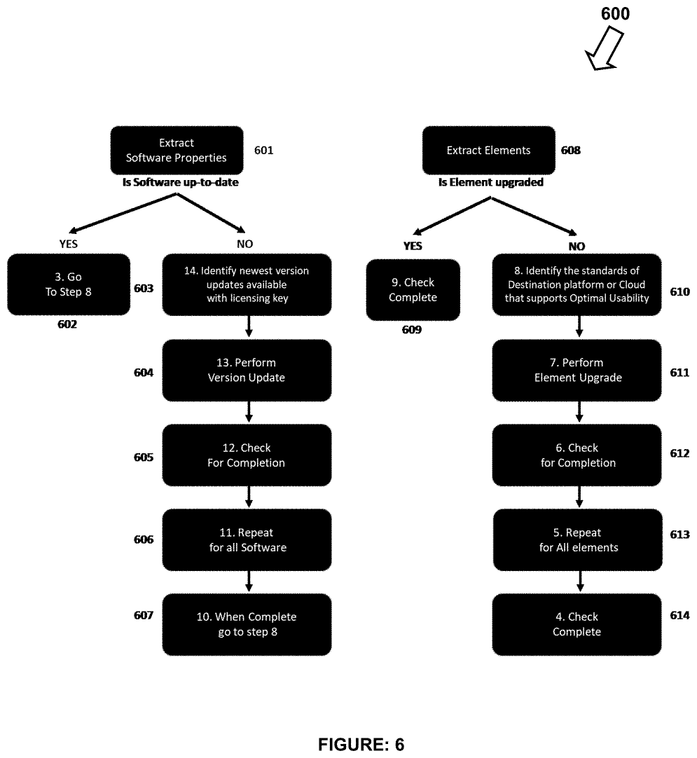

FIG. 6 is the flow diagram of software version updates and element standards upgrades.

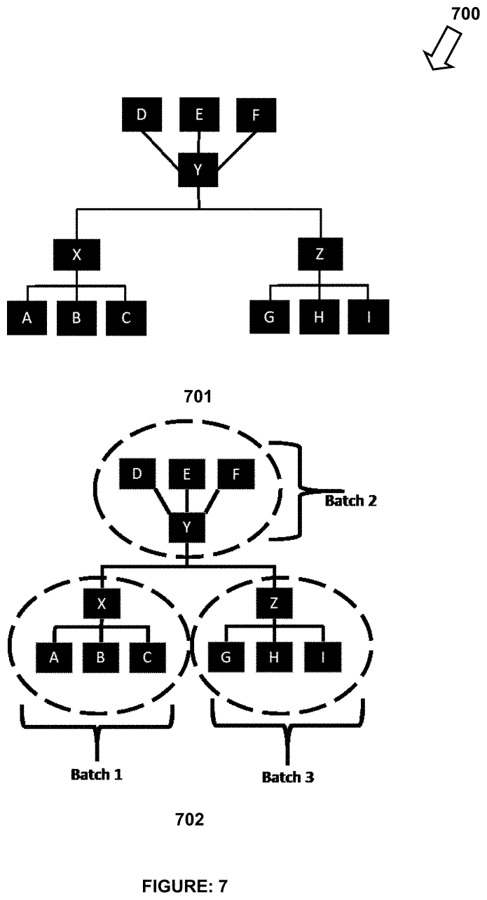

FIG. 7 is the packaging workload type 1.

FIG. 8 is the packaging workload type 2.

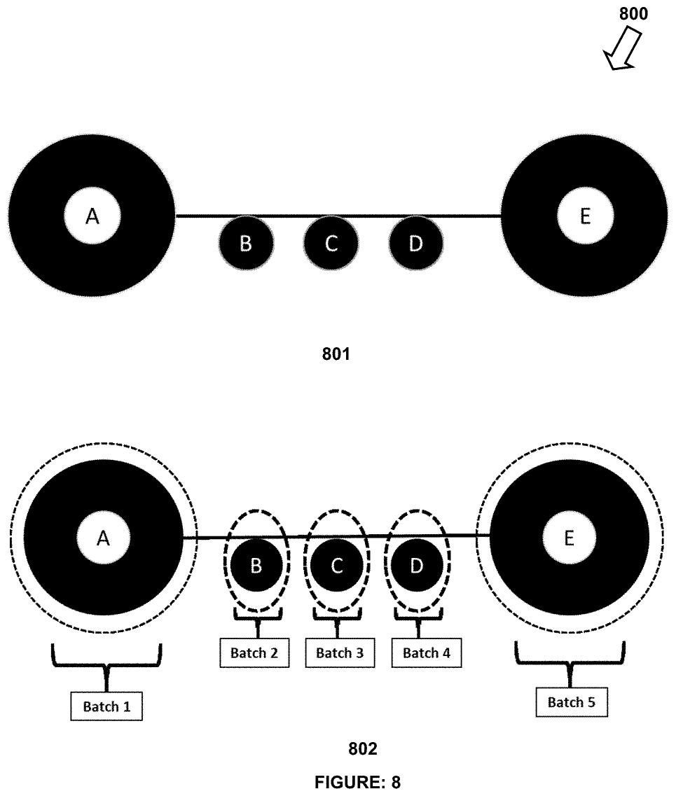

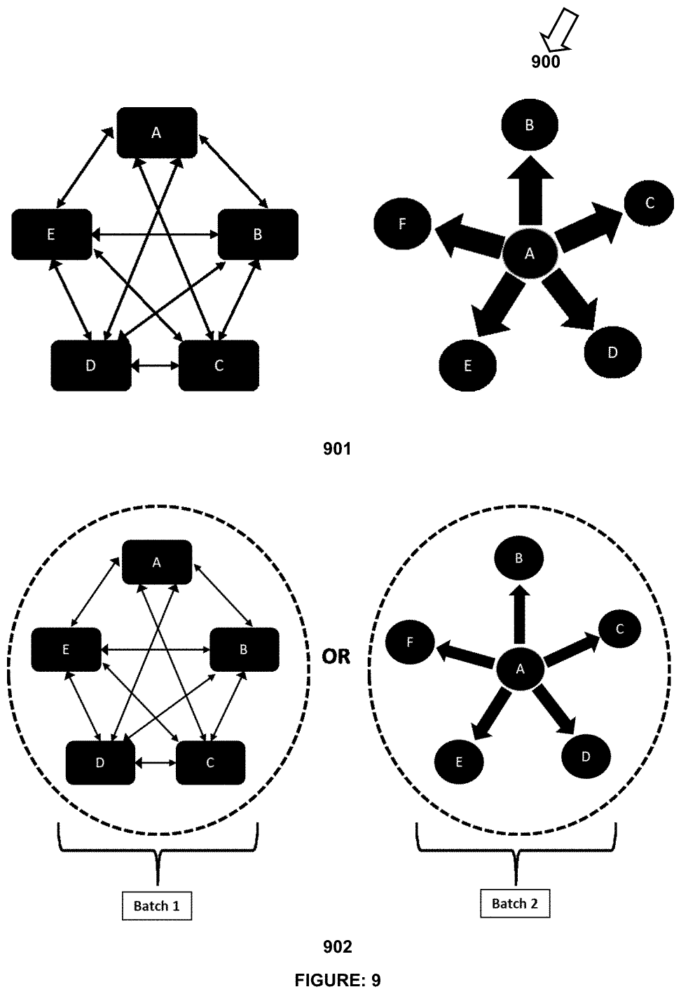

FIG. 9 is the packaging workload type 3.

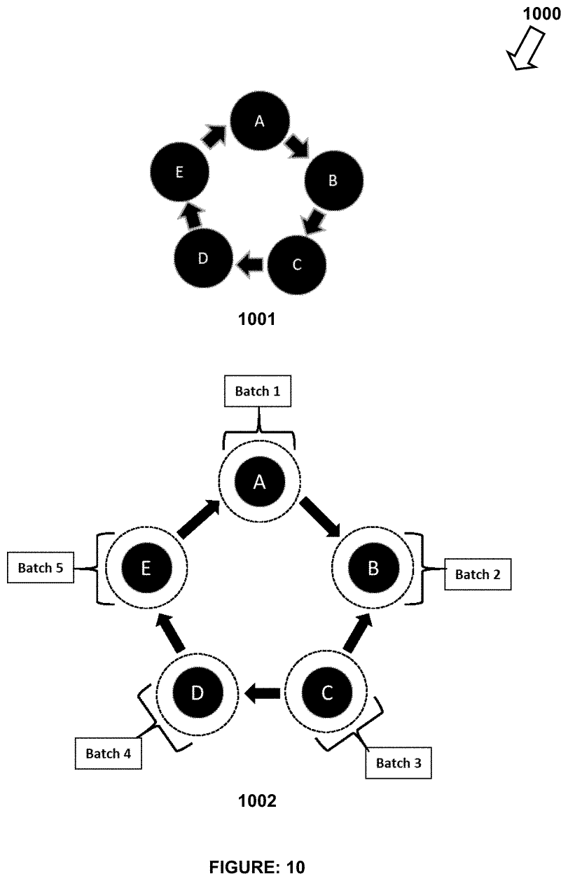

FIG. 10 is the packaging workload type 4.

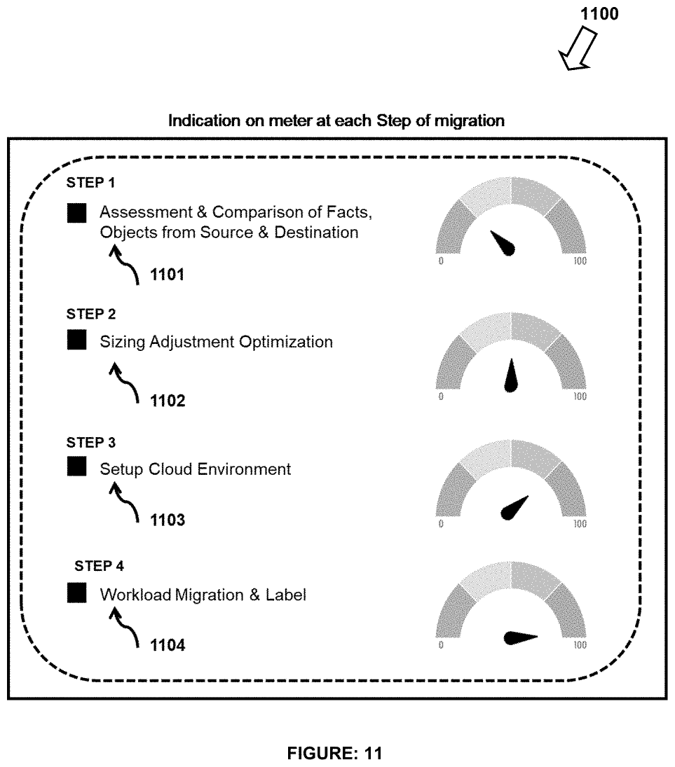

FIG. 11 is the UI indication of diagnostic meter at each step of cloud migration.

### DETAIL DESCRIPTION

The subject matter described in this specification relates to the data migration on cloud, need of update, upgrade of software while migration, licensing into cloud migration assessment, objects, facts, comparison, sizing scheduler. An update modifies current software while an upgrade totally replaces it. Upgrading is the process of replacing a product with newer version of the same product/software.

FIG. 1 is the flow chart of data migration on cloud. In cloud migration is undertaken to transfer data in various forms from one location (cloud) to another. Typically, this involved migration of all data from onsite server or other hosted environment over to data centers.

Method 100 includes extraction of objects, facts information from source cloud 101 and destination cloud 102. Before migrating information, it is needed to extract data, files, objects, facts etc. from source and destination cloud.

Inventory workload 103 includes an inventory of the infrastructure of source and destination cloud that consists of details about the servers, software, network device and storage. Inventory workload 103 includes existing application, the on-premises infrastructure resources that supports destination cloud and the workload interdependencies.

A workload is a collection of cloud resources and code that delivers business value such as customer-facing application or a backend process. A workload might consist of a subset of resources in a single cloud account or be a collection of multiple resources spanning multiple cloud accounts.

Before migrating workload to destination cloud, cloud provider will check the requirements of software version check. This will take care at system 104, it will perform version updates and standard upgrades. An upgrade is the act of replacing current software/product with a newer, and more often superior version. The differentiate between update & upgrade is update modifies current product/software while an upgrade totally replaces it.

System 105 includes labeling of licensing info of source and destination. All cloud customers are associate with one or more license packages. Licenses are required to run a cloud migration. To replicate a source machine as part of the migration it need information of all licenses package. A license enables the activation of data migration on cloud. The number of licenses depends on the number of machines in the source infrastructure which are involved in migration.

These licenses allow to perform multiple migration of files, objects, database, documents, personal archives etc. License management is one of the most important factors for cloud migration. While in migration one has to validate operating system licenses, application server licenses, and third-party tool licenses etc. While migration, cloud provider should validate weather the license can be moved or converted to cloud-based license or not.

After labeling the licensing information, system will check other parameters involved in migration and resize it according to the destination cloud 106.

In the section 106 cloud provider will map all the parameters involved in migration as per destination cloud. Basically, all source cloud attributes mapped with destination attributes. When the source and destination cloud get mapped with each other perfectly means the communication has been setup among the user, source cloud and destination cloud. Also, address has been shared between source and destination cloud. and finally, actual data migration takes place between source and target cloud.

Now the actual workload at source cloud converted into package workload 108. And the different package load will be migrated on destination cloud 109. Every package will have name at destination cloud when workload package will receive at destination cloud. It will send an acknowledgement or label the workload 110, this will indicate that the transmitted workload has been received successfully at destination cloud.

FIG. 2 is the block diagram of diagnostic meter for workload migration on cloud. The system described in 200 is consists of source workload 201, cloud migration assessment 202, setup cloud environment 203 for cloud migration, migrate workload 204, Checklist after migration 205 and Migration meter 206.

System 200 source workload 201 in cloud is the amount of processing that the computer has been given to do in given time. The workload includes diverse application and services. In the Cloud context the term workload refers to the type and characteristics of the application that are required to be hosted on the Cloud Different applications have different sets of requirements and characteristics. So, which applications can be hosted on the Cloud is largely dependent on the workload?

Before migration it is needed to determine all objects, facts etc. of source and destination cloud which are the part of migration. Objects, facts etc. of source and destination cloud are extracted for migration of data. This extraction of objects, facts etc. are the assessment for cloud migration 202 which is one of the important steps in cloud migration.

After assessment of objects, facts etc. system will setup the cloud environment 203, required for migration. These facts, objects etc. are mapped and resize according to destination cloud. Cloud migration setup will do this. And then workload get migrated 204 from one cloud to another cloud.

completion of migration system will check 205 the labels and make sure that all objects, facts, file, images etc. has been migrated on destination cloud. This check list 205 gives acknowledge of successful migration.

Migration meter 206 will give deflection at each stapes of migration. Diagnostic meter 205 will show 25% of deflection, when extraction of objects, facts, cloud migration assessment 202 are done. When system setup cloud environment 203 then migration diagnostic meter 206 will indicate 50% of indication. When complete workload migrated 204 from source to destination migration diagnostic meter will show deflection of 75%.

And finally when complete workload gets migrated on destination cloud, Checking of labeling takes place 205 and acknowledgement will be received to customer and then migration diagnostic meter will show 100% deflection. 100% deflection in migration diagnostic meter shows migration has been done successfully.

FIG. 3 shows the functional block diagram of diagnostic meter of workload migration. This block diagram consists of actual workload 301 at source, assessment of objects, facts from source and destination 302, destination cloud 303, setup of cloud environment for migration 306, scheduler for migration 318, workload migration with label 319 and diagnostic system migration meter 320.

At the start of migration process system will extract the objects, facts, images, files from sources cloud 301 and destination cloud 303 and is known as assessment of object, facts, etc. of source and destination cloud 302.

Actual source workload 301 is the amount of processing that the computer has been given to do in given time. The workload includes diverse application and services. In the Cloud context, the term workload refers to the type and characteristics of the application that are required to be hosted on the Cloud. Different applications have different sets of requirements and characteristics. So, which applications can be hosted on the Cloud is largely dependent on the workload?

Assessment of objects 302, file, images, facts etc. send to cloud environment setup 306 for migration. All these factors will pass through diagnostic system 304. Diagnostic system checks all parameters involved in migration are in proper format or not? After the diagnosis of facts, objects etc. cloud environment will check the licensing 307, sizing 308, and dependencies 309 of different parameters of source and destination cloud and accordingly map with each other for successful migration.

Diagnostic system 310 will do pre-validation of database 314, server 313, network security 315, user interface 312, compute 311, active or passive state, versions etc. Diagnostic system 310 will check each element listed and configure them as per requirement. And then performs update and upgrade 317 of software version required for migration.

Now source cloud is ready to migrate on destination cloud. Cloud migration setup 306 will schedule the migration 318. Scheduling allows to migrate data automatically at set time, so one can easily run migration in intervals or at off-hours.

Two options are available for migration scheduler. One option is, to schedule the migration for one time only, for a certain date and time. Or to schedule a schedule backup, which means every certain day during the week, at a certain time migration will be running.

After the scheduling, workload will migrate 319 in defined schedule and give acknowledge with label. After successful workload migration diagnostic migration 320 meter will show deflection 100%.

In FIG. 4A is showing the example of monolithic source architecture, here all elements are directly connected with each other. From the given 400, the 402 shows that the monolithic application is a single-tiered software application in which different components combined into a single program. In system 402 infrastructure elements has shown 402 like database, user interface, server. Diagnostic system 401 will check all these elements and make sure all these parameters mapped with destination cloud so migration process will be successful.

FIG. 4B, is the example of modular source architecture in 400. As shown in FIG. 4B is showing the application elements composed of separate components like databases 404, licensing sizing dependencies 405 of components, API 408, different services, web UI 409, Mobile UI 410, that can be connected to each other, network security 406,407 etc.

The beauty of modular architecture is that we can replace or add any one component (Module) without affecting the rest of the application. In the given example FIG. 4B it is interdependent, each app has a unique database schema, whereas data transfer between elements can be direct or mediated by API.

In the system 400 diagnostic system 403 will check the all the application elements and check whether they are ready for migration or not. If diagnostic meter finds some deficiency, then cloud environment will remove that deficiency.

System 500 shows different network topologies. Mainly two types of topologies have included here, one is Central network topology FIG. 5A mesh network topology 501, start network topology 502 and tree network topology 503. The second network topology has been mentioned is linear network topology FIG. 53, ring network topology 504 and bus network topology 505.

This network topologies will help users on the network to share the resources, in communication, file sharing, data files, hardware sharing etc.

Most common topologies are mesh 501 star 502, tree 503, ring 504 & backbone 505. AH these networks are highly reliable. Network topology plays a significant role in functioning of networks. Network topology reduce the operational and maintenance cost such as cabling cost.

System 600 shows the flow diagram of software version update & element standard upgrades while migration. At the start of migrations system will extract software properties 601. This step will check, IS software up-to-date or not? If software is updated version, then it will go to 602 step 8, where system will identify the standards of destination cloud that supports optimal usability 610, After that system will upgrade its elements 611 involved in migration. System will continuously check required elements are updated/upgraded or not 612 and it will repeat the process till system get ready for migration 613, 614.

If software is not up-to-date then system will identify the newest version updates available with licensing key 603 and perform software version up-dation 604. System will continuously check Software up-dation 605 and will repeat for all software elements get updated 606. After up-dation of all software system will go to step 8, 602 and will identify the standards of destination platform 610.

So, before migration user must check for software update 601 and software upgrade 608. If software version is not update then first update it 603 to 607, and if system is not upgraded then it will be upgraded first 610 to 614 and then migration takes place.

System 700 shows packaging workload type 1. 701 shows the modular architecture with central workload tree network topology. 702 is the package hub and its subsidiaries into batches. Batches indicates collection of resources and series of operations has to perform.

System 800 shows packaging workload type 2. 801 shows the modular source architecture with linear workload network topology. Here system will check the sequence and dependencies of element 802 with batch of workload. 802 is the package with each network element separately.

System 900 shows packaging workload type 3. 901 is monolithic source architecture with central workload ring, star network topology. 902 is the set of elements into one batch. System 1000 shows packaging workload type 4. 1001 is monolithic source architecture with linear workload ring network topology. 1002 is the set of elements into batches.

FIG. 11 shows the deflection at different steps 1100 of migration. After the assessment and comparison of facts, objects of source and destination cloud diagnostic meter will show 25% of deflection 1101. After the sizing adjustment of facts, objects etc. diagnostic meter will deflect and show 50% of deflection 1102. After cloud environment setup diagnostic meter will show 75% deflection 1103. And finally, diagnostic meter will deflect 100% when workload migrated completely with label 1104.

1. A method comprising:
Providing updating software versions and upgrading software to industry standards during the migration process;
Providing the extraction relevant object, facts information form source and destination cloud.

2. A method providing:
Automatic software update and upgrade, which eliminates the task of manually updating software.

3. A method including:
The destination object information is extracted from APIs provided by the preferred cloud provider.

4. A method provides:
Interoperability between the source and destination cloud by updating and upgrading the cloud software.

5. A method provides;
Labeling of licensing information of source and destination cloud and provide comparison and sizing of objects, facts etc. of source & destination cloud.

6. A method included;
Schedular, two types of scheduler are explained one is immediate and second is on set time and date.

7. A method provides;
Diagnostic system and diagnostic meter will check the system time to time and make sure that the system is ready for migration or not? Diagnostic meter shows deflection at different stage of cloud migrations. So that user will get an idea how much % the process of migration has done.
